(19) United States
(12) Patent Application Publication
(10) Pub. No.: US 2026/0142432 A1
(43) Pub. Date: May 21, 2026

(54) FLUID COUPLING FOR AN ELECTRIC CURRENT

(71) Applicant: DEERE & COMPANY, MOLINE, IL (US)

(72) Inventors: RANDALL L. LONG, COFFEYVILLE, KS (US); STACY K. WORLEY, COFFEYVILLE, KS (US); ZACHARIAH E. ALBERT, INDEPENDENCE, KS (US)

(21) Appl. No.: 18/952,685

(22) Filed: Nov. 19, 2024

(51) Int. Cl. H01R 39/64; G01M 3/16

(52) U.S. Cl. CPC H01R 39/646; G01M 3/165; H01R 2201/26

(57) ABSTRACT

A fluid coupling for transferring an electric current through a rotating joint includes a housing including an outer conductor and an outer insulator positioned between the housing and the outer conductor, a shaft including an inner conductor and inner insulator positioned between the shaft and the inner conductor, a first seal positioned between the housing and the shaft, a second seal positioned between the housing and the shaft, a first electrical wire connected to the outer conductor, a second electrical wire connected to the inner conductor, a third electrical wire connected to the housing, a chamber defined at least partially by the inner and outer conductors and the first and second seals, an electrically conductive fluid inside the chamber forming an electric connection between the inner and outer conductors.

### FIELD OF THE DISCLOSURE

The present disclosure relates to a fluid coupling for transferring an electric current through a rotating joint.

### BACKGROUND

Work vehicles can include an electrical connection at the interface between a stationary housing and a rotating shaft.

### SUMMARY

According to an aspect of the present disclosure, a fluid coupling for transferring an electric current through a rotating joint, includes a housing including an outer conductor and an outer insulator positioned between the housing and the outer conductor, a shaft including an inner conductor and inner insulator positioned between the shaft and the inner conductor, a first seal positioned between the housing and the shaft, a second seal positioned between the housing and the shaft, a first electrical wire connected to the outer conductor, a second electrical wire connected to the inner conductor, a third electrical wire connected to the housing, a chamber defined at least partially by the inner and outer conductors and the first and second seals, and an electrically conductive fluid inside the chamber forming an electric connection between the inner and outer conductors.

According to an aspect of the present disclosure, the inner and outer conductors each form a ring.

According to an aspect of the present disclosure, the inner and outer insulators each form a sleeve.

According to an aspect of the present disclosure, the chamber is further defined by the inner and outer insulators.

According to an aspect of the present disclosure, the first and second seals are positioned between the inner and outer insulators.

According to an aspect of the present disclosure, the electrically conductive fluid includes a non-metallic ionic solution.

According to an aspect of the present disclosure, the electrically conductive fluid includes gallium.

According to an aspect of the present disclosure, a controller is configured to determine whether there is a leak of the conductive fluid outside of the chamber based on an electric current in the third electrical wire detected via a sensor.

According to an aspect of the present disclosure, a controller is configured to determine whether there is a leak of the conductive fluid outside of the chamber based on when an electric current in the third electrical wire detected via a sensor is above a threshold.

According to an aspect of the present disclosure, a controller is configured to determine whether a repair is required based on an electric current in the third electrical wire detected via a sensor.

According to an aspect of the present disclosure, a work vehicle includes a fluid coupling for transferring an electric current through a rotating joint.

The above and other features will become apparent from the following detailed description and accompanying drawings.

### BRIEF DESCRIPTION OF THE DRAWINGS

The detailed description refers to the accompanying figures in which:

FIG. 1 is a perspective view of a work vehicle including a fluid coupling for an electric current, according to an implementation;

FIG. 2 is an end view of a fluid coupling for an electric current, according to an implementation;

FIG. 3 is a side view of a fluid coupling for an electric current, according to an implementation;

FIG. 4 is a cross-sectional view of a fluid coupling for an electric current, according to an implementation;

FIG. 5 is a side view of a fluid coupling for an electric current, according to an implementation;

FIG. 6 is a cross-sectional view of a fluid coupling for an electric current, according to an implementation;

FIG. 7 is a side view of a fluid coupling for an electric current, according to an implementation;

FIG. 8 is a cross-sectional view of a fluid coupling for an electric current, according to an implementation; and

FIG. 9 is a schematic diagram of a control system, according to an implementation.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

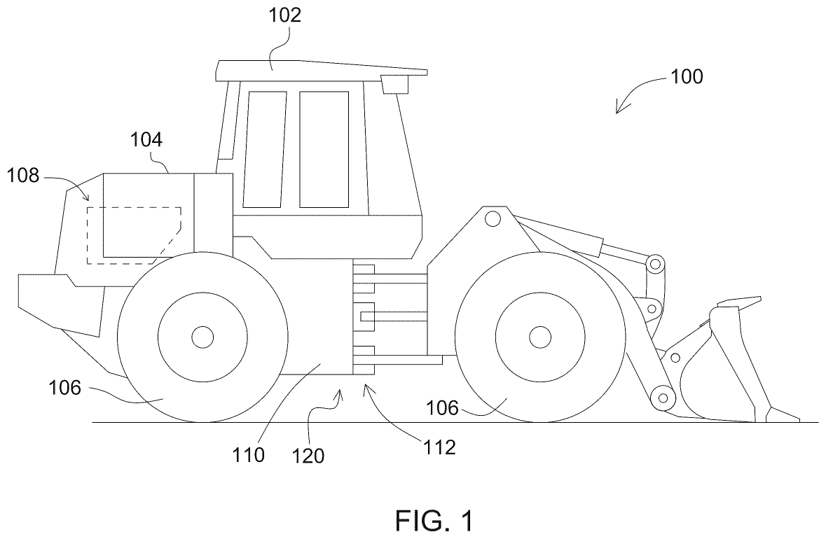

With reference to FIG. 1, a work vehicle 100, for example a loader, can include an operator station or cab 102, a hood 104, one or more ground engaging apparatus 106 (e.g., wheels or track assemblies), one or more power sources 108 (e.g., an internal combustion engine, a hybrid engine, a battery, an electric machine, or any combination of power sources), and a frame or chassis 110. The work vehicle 100 can have a rigid or an articulated frame or chassis 110. The work vehicle 100 can include a drivetrain 112 transferring power from the power source 108 to the ground engaging apparatus 106. The drivetrain 112 can include a transmission, one or more gearboxes, one or more final drives, and one or more other drivetrain components.

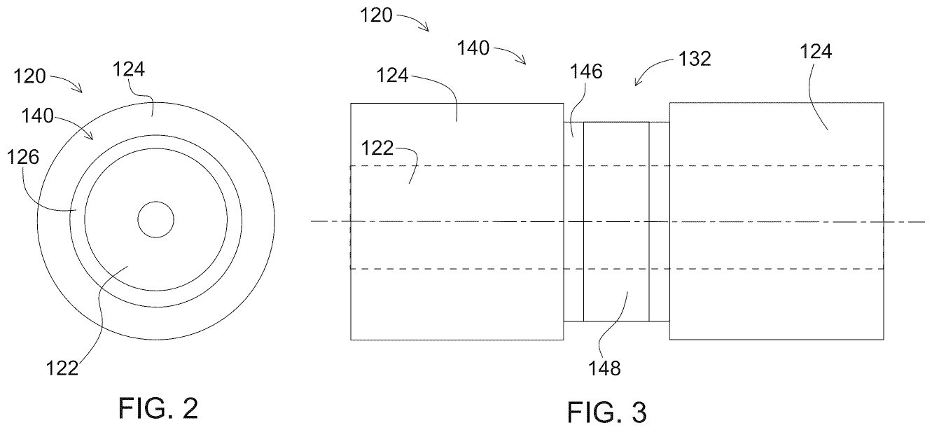

The drivetrain 112 can include one or more rotating connections 120 (e.g., a rotating shaft inside a stationary housing) in any of the drivetrain components. The work vehicle 100 can include an operator interface having any number and combination of electronic devices, such as an interactive display. The work vehicle 100 can include a fluid coupling 140 for an electric circuit to transfer an electric current through a rotating connection 120, as shown for example in FIGS. 2-8. The fluid coupling 140 can be included in the transmission, one or more of the gearboxes, one or more of the final drives, or any other drivetrain component. In some implementations, the fluid coupling 140 can conduct high voltage currents. This disclosure also applies to other types of work vehicles 100 in agriculture, construction, forestry, road building, turf, and utility.

With reference to FIGS. 2-8, a rotating connection 120 can include a rotating member 122, such as a shaft, and a stationary member 124, such as a housing. One or more bearings or bushings 126 can be positioned between the shaft 122 and the housing 124. A fluid coupling 140 can include an inner insulator 142, such as a non-conductive disk or ring, and an inner conductor 144, such as a conductive tube or sleeve, connected to the shaft 122. The fluid coupling 140 can include an outer insulator 146, such as a non-conductive disk or ring, and an outer conductor 148, such as a conductive tube or sleeve, connected to the housing 124.

The inner insulator 142 can be positioned between the shaft 122 and the inner conductor 144. The outer insulator 146 can be positioned between the housing 124 and the outer conductor 148. The inner and outer insulators 142, 146 can each form a partial or complete disk or ring. The inner and outer insulators 142, 146 can include any electrical insulator, such as ceramic. The inner and outer conductors 144, 148 can each form a partial or complete tube or sleeve. The inner and outer conductors 144, 148 can include any electrical conductor, such as copper or aluminum.

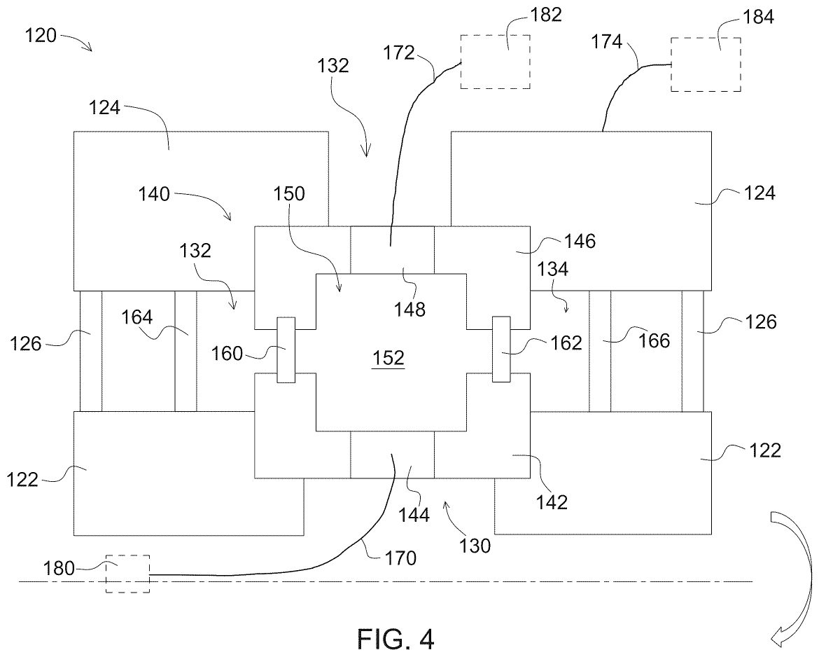

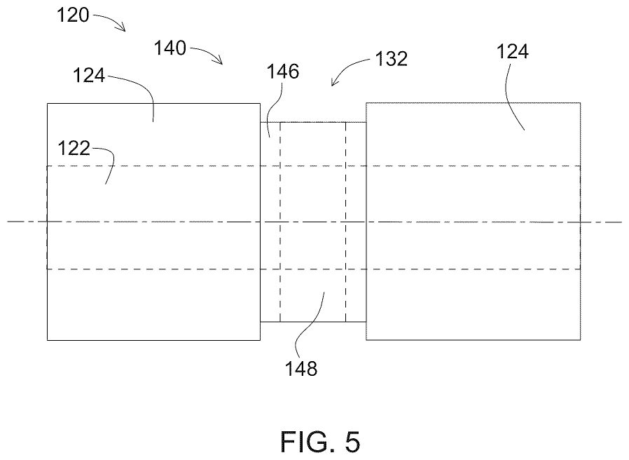

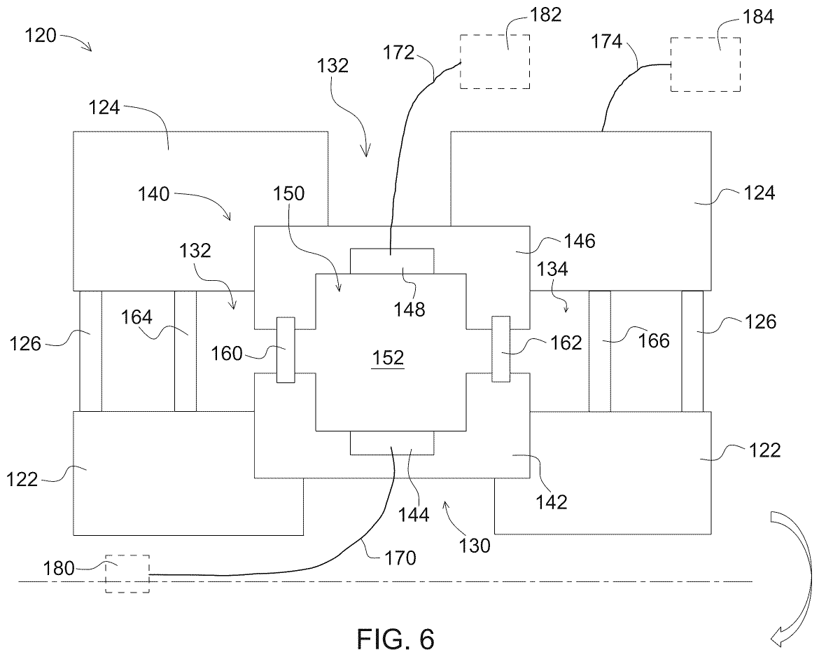

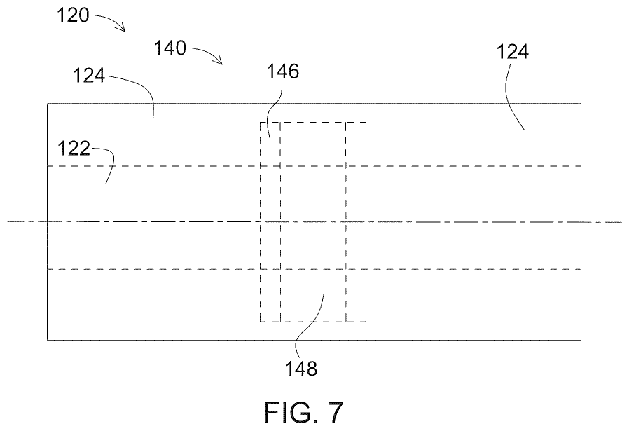

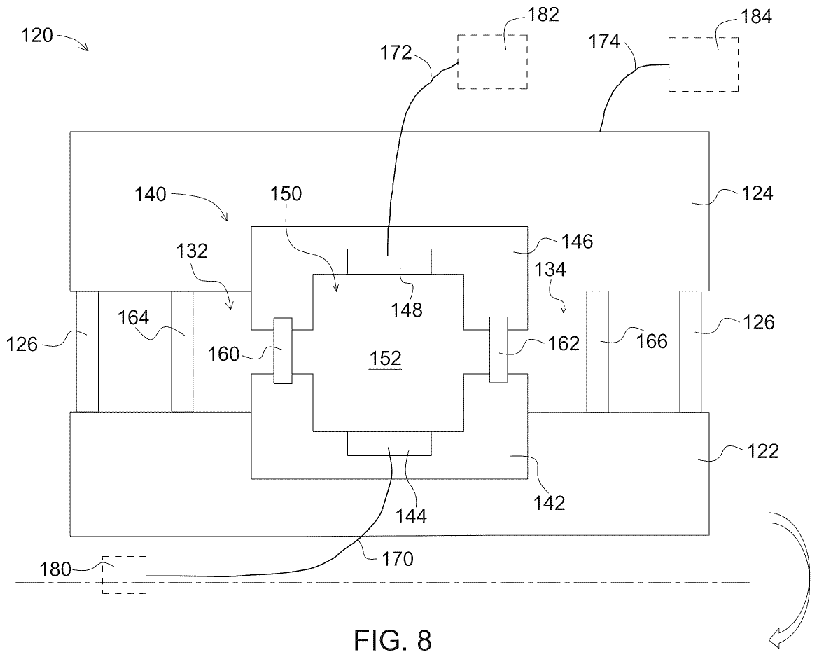

The inner conductor 144 can be electrically insulated or isolated from the shaft 122 by the inner insulator 142 and an air gap 130, as shown for example in FIGS. 3 and 4. The outer conductor 148 can be electrically isolated from the housing 124 by the outer insulator 146 and an air gap 132. The inner conductor 144 can be electrically insulated or isolated from the shaft 122 by the inner insulator 142 and the air gap 130, as shown for example in FIGS. 5 and 6. The outer conductor 148 can be electrically isolated from the housing 124 by the outer insulator 146 and the air gap 132. The inner conductor 144 can be electrically insulated or isolated from the shaft 122 by the inner insulator 142, as shown for example in FIGS. 7 and 8. The outer conductor 148 can be electrically isolated from the housing 124 by the outer insulator 146.

The inner conductor 144 and the outer conductor 148 can form at least a portion of an enclosure or a chamber 150 for an electrically conductive fluid 152 (e.g., a non-metallic ionic solution, gallium, or any other electrically conductive fluid). Additionally, one or more of the inner insulator 142 and the outer insulator 146 can form at least a portion of the enclosure or chamber 150 for the electrically conductive fluid 152. In some implementations, the inner conductor 144, the outer conductor 148, the inner insulator 142, and the outer insulator 146 can form the enclosure or chamber 150 for the electrically conductive fluid 152.

A first seal 160 can be positioned on a first side of the chamber 150 between the shaft 122 and the housing 124. The first seal 160 can be positioned between the inner conductor 144 and the outer conductor 148 or between the inner insulator 142 and the outer insulator 146. A second seal 162 can be positioned on a second side of the chamber 150 between the shaft 122 and the housing 124. The second seal 162 can be positioned between the inner conductor 144 and the outer conductor 148 or between the inner insulator 142 and the outer insulator 146. The first and second seals 160, 162 can enclose or seal the electrically conductive fluid 152 within the chamber 150.

A third seal 164 can be positioned on the first side of the chamber 150 between the shaft 122 and the housing 124 forming a second enclosure or chamber 134 between the first and third seals 160, 164. A fourth seal 166 can be positioned on the second side of the chamber 150 between the shaft 122 and the housing 124 forming a third enclosure or chamber 136 between the second and fourth seals 162, 166.

A first electrical wire 170 connects to the inner conductor 144 and to a first electrical component 180. A second electrical wire 172 connects to the outer conductor 148 and a second electrical component 182. An electric current can flow between the first and second electrical components 180, 182 through the first and second electrical wires 170, 172, the inner and outer conductors 144, 148, and the electrically conductive fluid 152 in the chamber 150.

A third electrical wire 174 connects to the housing 124 and to a sensor 184, which detects or measures an electric current in the third electrical wire 174. The sensor 184 can be any type of current sensor. If the conductive fluid 152 leaks past the first seal 160 and enters the second chamber 134 between the first seal 160 and the third seal 164 on one side of the chamber 150, then the conductive fluid 152 can form an electrical connection between the first electrical wire 170 or the second electrical wire 172 and the third electrical wire 174. If the conductive fluid 152 leaks past the second seal 162 and enters the third chamber 136 between the second seal 162 and the fourth seal 166 on the other side of the chamber 150, then the conductive fluid 152 can form an electrical connection between the first electrical wire 170 or the second electrical wire 172 and the third electrical wire 174.

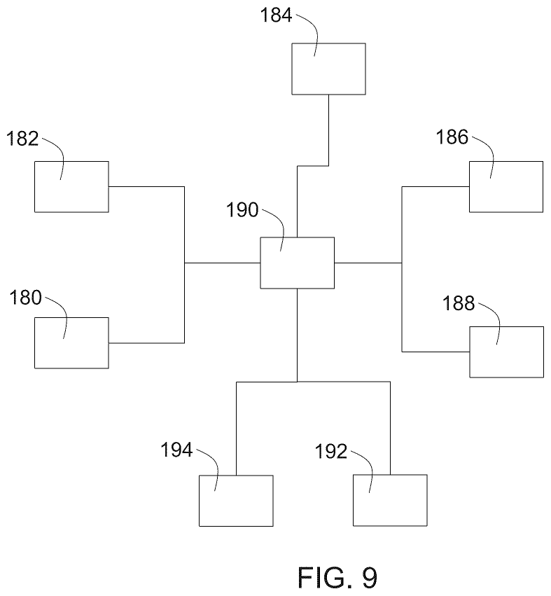

With reference to FIGS. 2-9, an electronic control unit or controller 190 can connect to one or more of the first electrical component 180, the second electrical component 182, and the sensor 184, an interactive display 186, an audio device 188, an electric energy source 192, and a remote electronic device 194. When there is an electrical connection with the third electrical wire 174, the sensor 184 detects or senses an electric current in the third electrical wire 174. The controller 190 can determine whether there is a leak based on the electric current in the third electrical wire 174 detected via the sensor 184. The controller 190 can determine whether there is a leak when the electric current in the third electrical wire 174 is at or above a threshold, which can represent an acceptable amount of electric current flowing through the housing 124. The threshold can be an upper limit of or maximum allowable electric current flowing through the housing 124. When the controller 190 determines there is leak, the controller 190 can generate a visual or audio alert on the interactive display 186 or audio device 188.

Alternatively or additionally, the controller 190 can reduce or terminate the electric current flowing through the conductive fluid 152 between the first and second electrical wires 170, 172 when a leak is detected. The controller 190 can reduce or limit the amount of electric energy provided by an electric energy source 192, such as a battery or electric generator when a leak is detected. Alternatively or additionally, the controller 190 can determine whether a repair is required 10 based on an electric current in the third electrical wire detected via the sensor 184. When the controller 190 determines a repair is required, the controller 190 can provide a repair notification via one or more of the interactive display 186, the audio device 188, or the remote electronic device 194. The repair notification can provide diagnostics regarding the seriousness and location of the leak prior to teardown, which allows for service and repair items to be procured prior to disassembly of the drivetrain component (e.g., transmission disassembly and repair).

The electronic control unit or controller 190 can have one or more microprocessor-based electronic control units or controllers, which perform calculations and comparisons and execute instructions, for example algorithms. The controller includes a processor, a core, volatile and non-volatile memory, digital and analog inputs, and digital and analog outputs. The controller can include non-transitory, computer readable memory, such as random-access memory (RAM), read only memory (ROM), or electrically erasable programmable read only memory (EEPROM), which include instructions for execution by the processor, for example algorithms. The controller connects to and communicates with various input and output devices including, but not limited to, switches, relays, solenoids, actuators, light emitting diodes (LED's), passive and interactive displays, radio frequency devices (RFD's), sensors, and other controllers. The controller receives communications or signals, via electrically or any suitable electromagnetic communication, from one or more devices, determines an appropriate response or action, and sends communications or signals to one or more devices. The controller can be a microprocessor, an application specific integrated circuit (ASIC), a digital processor, or a programmable logic controller, also known as a PLC or programmable controller. The controller can connect to and communicate with an electronic control system of the work vehicle through a data bus, such as a CAN bus, or the controller can be a part the electronic control system of the work vehicle.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A fluid coupling for transferring an electric current through a rotating joint, comprising:
a housing including an outer conductor and an outer insulator positioned between the housing and the outer conductor;
a shaft including an inner conductor and inner insulator positioned between the shaft and the inner conductor;
a first seal positioned between the housing and the shaft;
a second seal positioned between the housing and the shaft;
a first electrical wire connected to the outer conductor;
a second electrical wire connected to the inner conductor;
a third electrical wire connected to the housing;
a chamber defined at least partially by the inner and outer conductors and the first and second seals; and
an electrically conductive fluid inside the chamber forming an electric connection between the inner and outer conductors.

2. The fluid coupling of claim 1, wherein the inner and outer conductors each form a ring.

3. The fluid coupling of claim 1, wherein the inner and outer insulators each form a sleeve.

4. The fluid coupling of claim 1, wherein the chamber is further defined by the inner and outer insulators.

5. The fluid coupling of claim 1, wherein the first and second seals are positioned between the inner and outer insulators.

6. The fluid coupling of claim 1, wherein the electrically conductive fluid includes a non-metallic ionic solution.

7. The fluid coupling of claim 1, wherein the electrically conductive fluid includes gallium.

8. The fluid coupling of claim 1, further comprising a controller configured to determine whether there is a leak of the conductive fluid outside of the chamber based on an electric current in the third electrical wire detected via a sensor.

9. The fluid coupling of claim 1, further comprising a controller configured to determine whether there is a leak of the conductive fluid outside of the chamber based on when an electric current in the third electrical wire detected via a sensor is above a threshold.

10. The fluid coupling of claim 1, further comprising a controller configured to determine whether a repair is required based on an electric current in the third electrical wire detected via a sensor.

11. A work vehicle including a fluid coupling for transferring an electric current through a rotating joint, comprising:
a housing including an outer conductor and an outer insulator positioned between the housing and the outer conductor;
a shaft including an inner conductor and inner insulator positioned between the shaft and the inner conductor;
a first seal positioned between the housing and the shaft;
a second seal positioned between the housing and the shaft;
a first electrical wire connected to the outer conductor;
a second electrical wire connected to the inner conductor;
a third electrical wire connected to the housing;
a chamber defined at least partially by the inner and outer conductors and the first and second seals; and
an electrically conductive fluid inside the chamber forming an electric connection between the inner and outer conductors.

12. The work vehicle of claim 11, wherein the inner and outer conductors each form a ring.

13. The work vehicle of claim 11, wherein the inner and outer insulators each form a sleeve.

14. The work vehicle of claim 11, wherein the chamber is further defined by the inner and outer insulators.

15. The work vehicle of claim 11, wherein the first and second seals are positioned between the inner and outer insulators.

16. The work vehicle of claim 11, wherein the electrically conductive fluid includes a non-metallic ionic solution.

17. The work vehicle of claim 11, wherein the electrically conductive fluid includes gallium.

18. The work vehicle of claim 11, further comprising a controller configured to determine whether there is a leak of the conductive fluid outside of the chamber based on an electric current in the third electrical wire detected via a sensor.

19. The work vehicle of claim 11, further comprising a controller configured to determine whether there is a leak of the conductive fluid outside of the chamber based on when an electric current in the third electrical wire detected via a sensor is above a threshold.

20. The work vehicle of claim 11, further comprising a controller configured to determine whether a repair is required based on an electric current in the third electrical wire detected via a sensor.
